(19) United States
(12) Patent Application Publication
(10) Pub. No.: US 2004/0000054 A1
(43) Pub. Date: Jan. 1, 2004

(54) Vibrating utensil

(76) Inventor: Susan Sommer, St. Louis, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/183,910

(22) Filed: Jun. 27, 2002

(51) Int. Cl. A47J 43/28

(52) U.S. Cl. 30/123; 30/142; 30/324

(57) ABSTRACT

A utensil for neurologically impaired or immature persons that has a part to be introduced to the mouth of the person, and a vibrating handle operatively connected to the part and adapted to vibrate continuously while it is being used. In the preferred embodiment, the part to be introduced to the mouth is a food-holding utensil such as a spoon, which is preferably coated with a resilient, durable coating, or else made of plastic or the like resilient material. In the use of the preferred embodiment of utensil, the utensil is put within the reach of the person to use it, and caused to vibrate continuously, so that when the person touches the handle and feels the vibration he is stimulated to grasp the handle and guide the spoon or fork to his mouth. Alternatively, the handle of the utensil can be placed within the grasp of the person, who can then grasp the handle securely and guide the spoon or fork to his mouth.

### REFERENCE TO RELATED APPLICATIONS

### STATEMENT REGARDING FEDERALLY SPONSORED RESEARCH OR DEVELOPMENT

Not Applicable

### BACKGROUND OF THE INVENTION

Severely neurologically impaired individuals exhibit significant difficulties with lip closure, palatal tongue thrust when moving a bolus to the swallow phase, tongue lateralization and manipulation of the bolus within the oral cavity. Small children, also, sometimes need help in developing their feeding skills. There are also among the neurologically impaired, those who chew on their fingers for self stimulation.

One of the objects of this invention is to provide an eating utensil to those individuals who have difficulty maintaining grasp on a feeding utensil, by providing sensory input to the central nervous system.

Another object is to provide such an eating utensil which will assist with increasing body awareness to an individual through the vibration and sensory input to the central nervous system.

Yet another object is to provide a stimulation to typically developing individuals for normal eating patterns.

Still another object is to provide a satisfactory substitute for the self stimulation of fingers of those individuals who habitually chew on their fingers.

Objects will occur to those skilled in the art in light of the following description and accompanying drawings.

### BRIEF SUMMARY OF THE INVENTION

In accordance with this invention, generally stated, a utensil is provided with a self-contained vibrating handle adapted to vibrate continuously while in use. The vibration of the handle provides stimulation to the proprioceptive receptors in the finger flexors of the hand and allows for the primitive grasp reflex to be facilitated, which in turn increases an individual's ability to maintain a grasp on the handle. It also allows an individual to know where the hand is in space, and where it is as it relates to the utensil and plate.

With the ability to maintain grasp on the vibrating utensil, an individual is able to work toward independence with self feeding.

The vibration of the utensil also works to provide stimulation to the lips, oral cavity and tongue and facilitates an individual's tongue thrust and oral motor control.

Preferably the utensil is a feeding utensil, with a part, such as a spoon, operatively connected to the vibrating handle, so that the spoon is also vibrated. The spoon is preferably either made of a resilient material or is made of stainless steel or the like, coated with a resilient material.

For the neurologically impaired, the utensil facilitates the grasp reflex to assist holding the utensil; facilitates neurological awareness to the hand to maintain grasp on the utensil; provides sensory input to the hand as it relates to the body, to provide awareness in space; provides sensory awareness to the tongue to assist with swallowing; facilitates the orbicularis muscles around the mouth to assist with lip closure; stimulates the tongue when utensil is placed in the mouth to facilitate palatal tongue thrust; provides sensory input to the oral cavity to increase awareness in the oral cavity, and improves basic feeding skills for typically developing individuals, among other things.

In practice, it has been found that neurologically impaired children, who have in some cases never been able to grasp a spoon or fork and to guide it to their mouths, have suddenly been enabled to grasp the vibrating utensil and to guide it to their mouths unassisted, to the amazement and delight of their care givers. Other neurologically impaired children have been content to chew on the vibrating utensil rather than on their fingers.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a top plan view of one embodiment of utensil of this invention;

FIG. 2 is a sectional view taken along the line 2-2 of FIG. 1;

FIG. 3 is a sectional view taken along the line 3-3 of FIG. 1; and

FIG. 4 is a view in rear elevation.

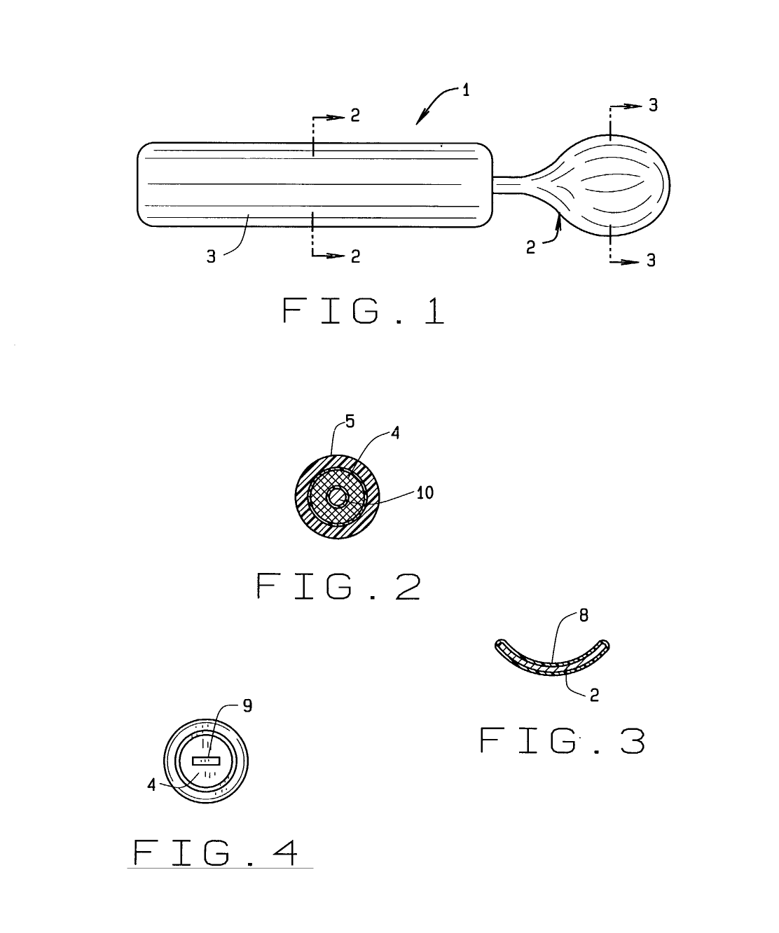

Corresponding reference characters indicate corresponding parts throughout the several views of the drawings.

### PREFERED EMBODIMENT

Referring now to the drawings for one illustrative embodiment of this invention, reference numeral 1 indicates the assembled utensil, which is made up of a food-holding part 2, in this embodiment a spoon, and a vibrating handle 3, including a vibrator 4 and a layer of cushioning material 5, placed over the vibrator to assist with grasping. The bowl of the spoon and a short section of the handle of the spoon are coated with a durable rubber coating 8.

The vibrator 4 has an on/off switch 9, and is powered by a battery 10, shown somewhat schematically, contained within a housing of the vibrator. The battery 10 can be rechargeable or not. If rechargeable, the utensil can be supported in charging position on a stand, as electric tooth brushes are commonly done, and the switch relocated to accommodate a different configuration of the handle.

The food-holding part of the utensil can be of any desired configuration, such as a normally shaped fork or spoon, a right curved fork or spoon or a left curved fork or spoon or the like. The vibrator can be of any sort, such as motor driven eccentric, buzzer, or reciprocating, for example. Means, such as a rheostat or electronic speed control, can be provided in or on the vibrator to vary the frequency of the vibration to suit the needs of different individuals, or a different vibrator can be employed, suitable vibrators being inexpensive and readily available commercially. If the vibrator is equipped with an off-center weight, the amplitude of the vibrations can be varied by changing the weight, or using a vibrator with a different weight.

In use, the utensil can be put within the reach of the subject user, and turned on so that the handle is vibrating continuously. If necessary, the utensil can be placed in the hand of the user, who then can grasp the handle and guide the food holding part to and into his mouth. The same approach can be used with immature children without impairments, to improve their developmental feeding skills.

Although the primary purpose of the invention is to facilitate eating, as has been noted, the device has benefits for children who habitually chew on their fingers, and although the food-holding part can be used to provide a substitute for the fingers, a different configuration can be used, emulating the figures for example. In use, the part that enters the mouth should extend between the lips and over a portion of the tongue of the person.

Numerous other variations within the scope of the appended claims will occur to those skilled in the art in the light of the foregoing disclosure. For example, the part to be put in the mouth can be coated with epoxy, polyethylene, polypropylene, or any other non-toxic, resilient and durable coating material, besides rubber. The handle can be made of a size and shape to suit the needs of the person using it, with or without an overlying spongy cover. If a cover is used, it can be in the form of a sleeve of foamed plastic, or a sprayed or dipped coating, or a two- or multi-part cover. For those persons whose problem is primarily the chewing of fingers or a difficulty in manipulating the tongue, the vibration of the handle can be minimized, the vibration of the element going into the mouth being the more important consideration. The spoon can be of a conventional type, and the handle of the spoon simply inserted between the spongy cover and the vibrator, or taped to the vibrator. Alternatively, the spoon handle and vibrator can be adapted to be clamped or otherwise connected, or the handle and food holding part can be made in one piece (cf. U.S. Pat. No. 5,075,970). These variations are merely illustrative.

Having thus described the invention, what is claimed and desired to be secured by Letters Patent is:

1. An eating utensil for neurologically impaired or immature persons, comprising a food holding part and a connected self-contained vibrating handle adapted to vibrate and to vibrate said food holding part continuously while it is being used.

2. The utensil of claim 1 wherein the food holding part is coated with a resilient, durable coating.

3. The utensil of claim 1 wherein the food holding part is a spoon.

4. The utensil of claim 2 wherein the food holding part is made of stainless steel.

5. A utensil for providing sensory stimulation to the mouth of a neurologically impaired person, comprising a part to be put into the mouth, between the lips and over at least a part of the tongue of the person, and a handle connected to said part, said handle containing means for vibrating said part continuously while the utensil is in use.

6. The utensil of claim 1 wherein the handle is covered with a spongy material.

7. The utensil of claim 5 wherein the handle is covered with a spongy material.

8. A method of feeding a neurologically impaired or immature person comprising putting within his reach a utensil having a food holding part and a handle that is vibrating continuously.

9. A method of feeding a neurologically impaired or immature person comprising putting within his grasp a utensil having a food holding part and a handle that is vibrating continuously.

10. A method of providing relief to a neurologically impaired person comprising introducing to the mouth of said person a vibrating element, said element extending between the lips and over at least a part of the tongue of the person, and vibrating continuously while in use.

11. The utensil of claim 1, including means for varying the frequency of vibration of the vibrating handle.
